(19) United States
(12) Patent Application Publication
(10) Pub. No.: US 2008/0307194 A1
(43) Pub. Date: Dec. 11, 2008

(54) Parallel, Low-Latency Method for High-Performance Deterministic Element Extraction From Distributed Arrays

(75) Inventors: Charles J. Archer, Rochester, MN (US); Michael A. Blocksome, Rochester, MN (US); Joseph D. Ratterman, Rochester, MN (US); Brian Smith, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/758,692

(22) Filed: Jun. 6, 2007

(51) Int. Cl. G06F 9/30

(52) U.S. Cl. 712/10; 712/E09.005

(57) ABSTRACT

The present invention provides a system and method for extracting elements from distributed arrays on a parallel processing system. The system includes a module that populates a local array with elements from input, a module that submits a largest element value in the local array and a processor ID for a local processor, and a module that determines a globally largest element value from the largest element values submitted by each one of the plurality of processors. The system further includes a module that broadcasts a winning globally largest element value and winning processor ID to the plurality of processors, and a module that increments an element pointer to the next value in the local array if the winning processor ID equals the processor ID for the local processor.

### CROSS-REFERENCE TO RELATED APPLICATION

This application is related to co-pending U.S patent application entitled “PARALLEL, LOW-LATENCY METHOD FOR HIGH-PERFORMANCE SPECULATIVE ELEMENT EXTRACTION FROM DISTRIBUTED ARRAYS” filed on Jun. 5, 2007, and having Attorney docket # ROC920070229US1 and accorded Ser. No. ______, which is entirely incorporated herein by reference.

### FIELD OF THE INVENTION

This invention relates generally relates to methods and apparatus for array processing and particularly to a high-performance element extraction from distributed arrays on a parallel processing system.

### DESCRIPTION OF BACKGROUND

Currently, in certain large-scale parallel applications, it is sometimes helpful to be able to find the globally largest N items out of distributed lists on P nodes.

This is particularly important in bio-informatics applications, where finding the best matches to an item is a common step in the process. These algorithms are useful in the BLAST application. There are a number of approaches to this problem, although none are particularly efficient. Applications typically do a gather operation to a root node and then a local sort/search on that node. Gather operations do not scale well and require large amounts of memory. The local sorting searching is also quite time consuming.

### SUMMARY OF THE INVENTION

Embodiments of the present invention provide a system and method for extracting elements from distributed arrays on a parallel processing system. Briefly described, in architecture, one embodiment of the system, among others, can be implemented as follows. The system includes a module that populates a local array with elements from input, a module that submits a largest element value in the local array and a processor ID for a local processor, and a module that determines a globally largest element value from the largest element values submitted by each one of the plurality of processors. The system further includes a module that broadcasts a winning globally largest element value and winning processor ID to the plurality of processors, and a module that increments an element pointer to the next value in the local array if the winning processor ID equals the processor ID for the local processor.

Embodiments of the present invention can also be viewed as providing methods for extracting elements from distributed arrays on a parallel processing system. In this regard, one embodiment of such a method, among others, can be broadly summarized by the following steps. The method operates by populating a local array with elements from input, submitting a largest element value in the local array and a processor ID for a local processor, and determining a globally largest element value from the largest element values submitted by each one of the plurality of processors. The method further operates by broadcasting a winning globally largest element value and winning processor ID to the plurality of processors, and incrementing an element pointer to the next value in the local array if the winning processor ID equals the processor ID for the local processor.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a virtual network configuration utilizing integrated diagnostics through signaling methods of the present invention embodiments.

FIG. 2 is a block diagram example of an array of elements utilized by the CPUs and GCN as shown in FIG. 1.

FIG. 3 is a flow charts of the deterministic array evaluation process that finds the largest global element in each iteration method of the present invention.

FIG. 4 is a flow charts of the speculative array evaluation process that makes an educated guess about a part cushioning value method of the present invention.

The detailed description explains the preferred embodiments of the invention, together with advantages and features, by way of example with reference to the drawings.

### DETAILED DESCRIPTION OF THE INVENTION

The invention addresses problems with massively parallel supercomputers. In certain large-scale parallel applications, it is sometimes helpful to be able to find the globally largest N items out of distributed lists on P nodes.

One such example where this operation of combining the globally largest N items out of the distribution list on P nodes is important, is in the area of biomolecular simulations to study protein science. The life sciences are receiving special attention because the field is demonstrating explosive growth, and the life sciences are creating what will become one of the most significant industries of the new century. Indeed, with advances in bioinformatics and genomics, high-throughput screening of drug candidates, and ready access to information on the Internet, the life sciences have benefited from computational capabilities and will be driving the requirements for data, network, and computational capabilities in the future. The particular area of protein folding includes the need for determining the best docking sites for molecules and proteins. The understanding of the protein folding phenomenon is a recognized “grand challenge problem” of great interest to the life sciences.

Increased computational power translates into an increased ability to validate the models used in simulations and, with appropriate validation of these models, to probe these biological processes at the microscopic level over long time periods. A critical component of the research will be the connection of the simulations to the experimental biophysics of protein dynamic.

One such example of a massively parallel supercomputer to accomplish this is the BlueGene/L (BG/L). BG/L is a massively parallel supercomputer that contains 65536 nodes, and is interconnected by specialized networks. The combinations of low-power chips and specialized networks have allowed BG/L to reach petaflop scale computing. Scalable parallel algorithms that utilize these networks are increasingly important.

This document defines two new methods, both which make use of a vast global combining network and this computational power. In both methods, it is assumed that the local arrays are sorted on each processor node, but there is no global order. Local arrays should be at least N elements long, so padding can be performed if necessary. In an alternative embodiment, a trivial change to the methods would remove the requirement for padding.

The two methods are defined as a deterministic and a speculative. The deterministic method makes a loop N times and finds the largest global element remaining in each iteration for each position in the array. The speculative method repeatedly attempts to make an educated guess about a partitioning value. The nodes then repeatedly sum the number of elements on each node greater than the partition element and choose a new partitioning element, until the total is equal to N.

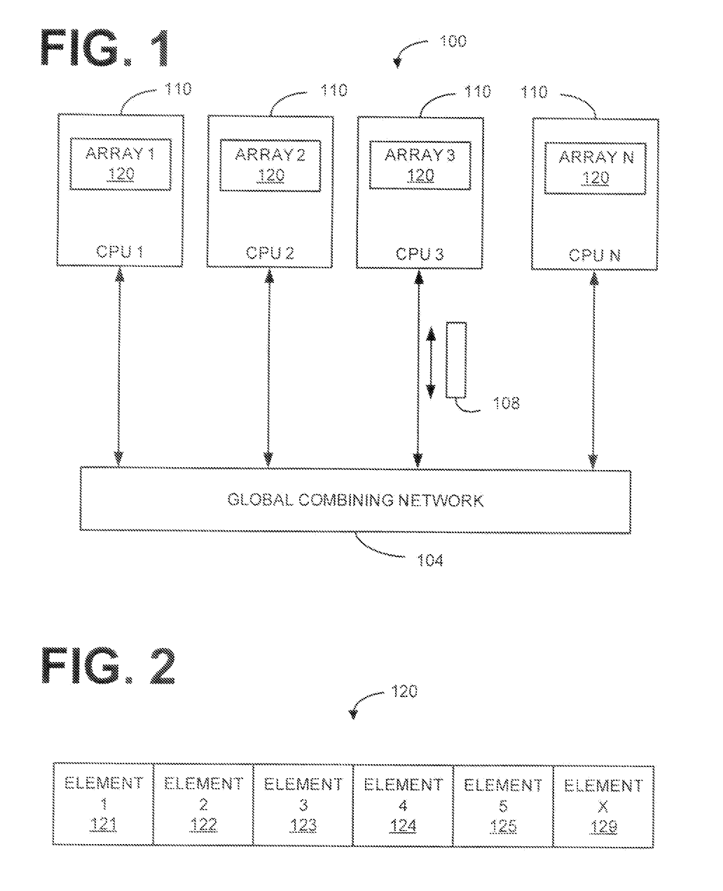

FIG. 1 is a block diagram illustrating a configuration of a parallel supercomputer (i.e. computer system) utilizing the parallel, low latency methods for high-performance element extraction from distributed arrays methods of the present invention. The configuration contains a physical machine 100 coupled via a global combining network 104. A physical machine 100 is a parallel processing system suitable for storing and/or executing program code will include multiple processors coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including, but not limited to keyboards, displays, pointing devices, etc.) can be coupled to the system either directly or through intervening I/O controllers. Network adapters may also be coupled to the system to enable the parallel processing system to become coupled to other data processing systems or remote printers or storage devices through intervening private or public networks. Modems, cable modem and Ethernet cards are just a few of the currently available types of network adapters.

While the present invention is not limited to any particular hardware or software platform, in a exemplary embodiment the physical machine 100 may constitute an IBM™ BlueGene/L (BGL) or P (IBM and BlueGene are trademarks of IBM Corporation). Global combining network 104 (also referred to herein as a GCN) forwards data packets 108 between CPUs 110 on physical machine 100. GCN 104 may be an internal network, such as one or more specialized networks, local area network (LAN) within an organization, an external network, or a combination of both and may have other physical machines or devices (not shown) coupled to it.

FIG. 2 is a block diagram example of an array 120 of elements 121-129 utilized by the CPUs 110 and GCN 104 as shown in FIG. 1. It is the array 120 on each CPU 110 that utilizes the high-performance element extraction from distributed arrays methods (i.e. a distributed array element extraction system) of the invention. The array 120 includes a plurality of elements 121-129. In an exemplary embodiment, elements 121-129 are sorted in descending order of the value. In the exemplary bio-informatics application, the element values in the array 120 indicate the best docking sites on a protein or molecule being modeled. Thus, it is sometimes helpful to be able to find the globally largest N items of the distributed arrays on multiple nodes.

This disclosure illustrates two new methods, both of which make use of a fast global combining network. These methods include the Iterative/Deterministic version and Partitioning/Speculative version. Iterative/Deterministic version. This one makes a loop N times, and finds the largest global element remaining in each iteration. Partitioning/Speculative version. This one repeatedly attempts to make an educated guess about a partitioning value. The nodes then repeatedly sum the number of elements on each node greater than the partition element and choose a new partitioning element, until the total is equal to N.

In these methods, the MPI Allreduce( ) function is utilized. The MPI Allreduce( ) function can be described as a function that combines all values on all processors using an arithmetic operation into a single value. These arithmetic operations would be done using the global combining network 104. Then the operation is followed by broadcast which broadcasts the largest value found in all arrays 120 in all CPUs 110. The CPU 110 having the largest element in its array 120 then removed that element from further comparison in any subsequent operation of the MPI Allreduce( ) function.

In both cases, the methods assume that the local arrays are sorted, but there is no global order. The local arrays are at least N elements long. Padding is utilized if necessary, although a trivial algorithm change would remove a requirement for padding. If the local arrays are longer than N, one can clearly disregard the extra elements since there is no way that they could be part of the result.

For the timing discussions below, A(P) will be use to represent the time it takes to do an MPI Allreduce( ) function over P nodes. On BGL, A(P) is upper-bounded by Ln(P), with a very small constant. Other systems are able to achieve the O(Ln(P)) performance, but they generally have much larger constants which would make these approaches unreasonable.

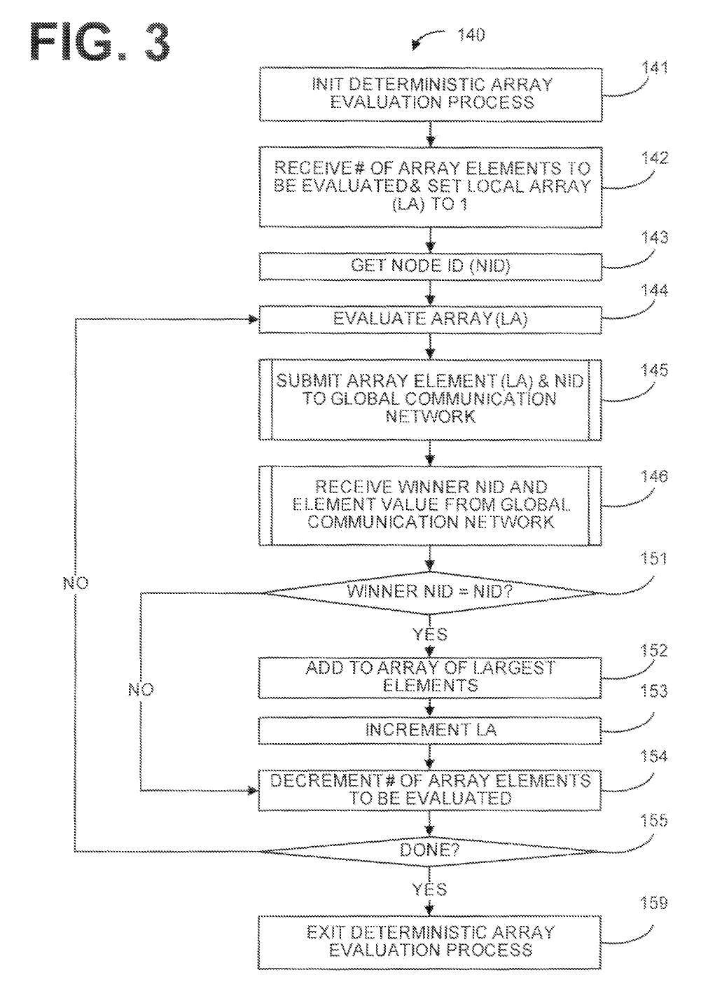

FIG. 3 is a flow chart of the deterministic array evaluation process 140 that finds the largest global element in each iteration method of the present invention. Given two arrays 120 (one input and one output) and their length, the following steps populate the result array 120 with the globally largest elements from the input: Loop over each element 121-129 in the result array 120. Allreduce over all nodes, using the “current” element on each node, with operation MAX. Store the result in the result array 120. Whichever node contributed the largest element will advance its “current” element pointer to the next value in the input array.

The expected time for this to run is 0 (N*A(P)). This is clear, since the for loop will execute exactly N times, and the body of the loop will take A(P) time. More concretely, the following C/MPI code does the above for arbitrary integer arrays:

```
void biggest_N(int *narray, int *result, int size, MPI_Comm comm)
int i, point=0;
int rank;
struct {
    int data;
    int rank;
} work;
MPI_Comm_rank ( comm , &rank) ;
For (i=0; i<size; ++i) {
    work.rank = rank;
    work. data = narray[point];
    MPI_Allreduce(MPI_IN_PLACE, &work, 1, MPI_2INT,
MPI_MAXLOC, comm);
    if (work .rank ==. rank)
        ++point;
    result [i] = work.data;
    }
}
```

Now the code above will be described with regard to the flowchart in FIG. 3. First, the deterministic array evaluation process 140 is initialized to step 141. The initialization includes the establishment of data values for particular data strictures utilized in the deterministic array evaluation process 140. At step 142, a number is received indicating the number of elements 121-129 in the array 120 are to be evaluated. Also at step 142, the local array pointer is set to one said that the process evaluates the first element in the array 120.

At step 143, the deterministic array evaluation process 140 gets the node ID for the CPU 110. At step 144, the array is evaluated. At step 145, the deterministic array evaluation process 140 submits the array element, and node ID to the global combining network 104. At step 146, the winning node ID and element value are received from the global combining network 104.

At step 151, it is determined if the current CPU 110 is equal to the winning node ID. If it is determined at step 151 that the current CPU 110 is not the winning node ID, then the deterministic array evaluation process 140 then skips the step 154. However, if it is determined in step 151 that the current CPU 110 is the winning node ID, then the deterministic array evaluation process 140 at the submitted array element to the array of largest element at step 152. At step 153, the pointer to the local array 120 is incremented to point to the next element in the array 120.

At step 155, the deterministic array evaluation process 140 determines if there are more array elements to be evaluated. If it is determined at step 155 that there are more elements 121-129 in array 120 to be evaluated, then the deterministic array evaluation process 140 returns to repeat steps 144-155. However, if it is determined at step 155 that there are no more elements 121-129 in array 120 be evaluated, then the deterministic array evaluation process 140 then exits at step 159.

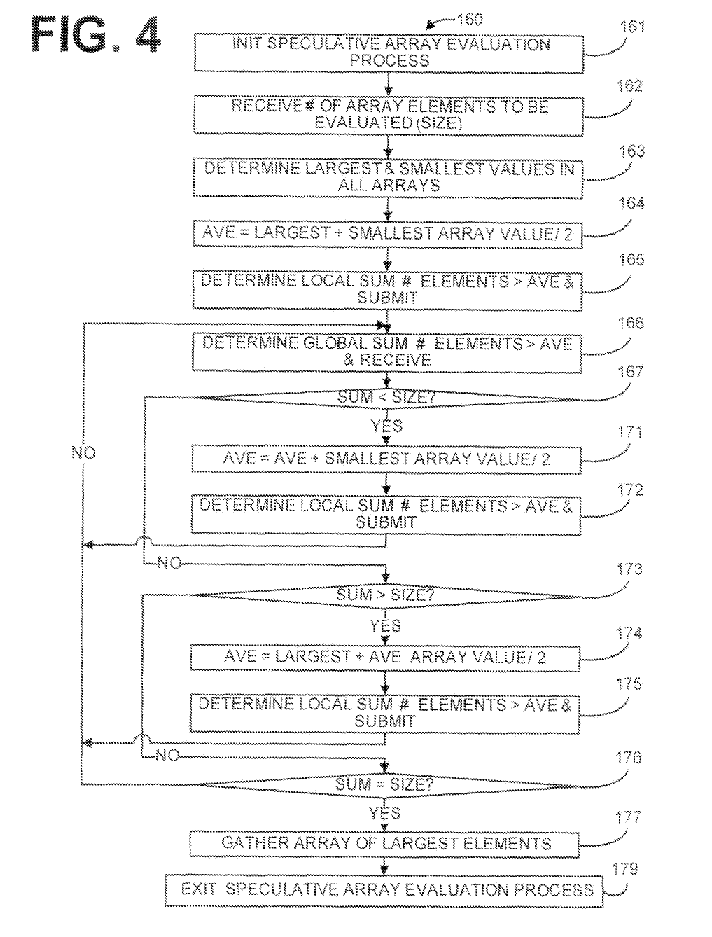

FIG. 4 is a flow charts of the speculative array evaluation process 160 that makes an educated guess about a part cushioning value method of the present invention. Given two arrays (one input and one output) and their length, the following steps populate the result array with the globally largest elements from the input. Choose a partition element O(A(P)). Count the number of local elements greater than the partition O(N*). Sum the local count to find the global count O(A(P). While (global count doesn't equal N) O(Ln(N)): Choose new partition O(1); Count the number of Local elements greater than the partition O(N*) and Sum the local count to find the global count O(A(P)). Repeat.

This method is noticeably more complicated than the first. Since the loop resembles a binary search, one can expect that it will take O(Ln(N) iterations. Choosing a partition can be done easily, so that is a simple O(1), except on the first, where two Allreduces are used to calculate the bounds for an initial partition choice. Since the Allreduce used to find the sum is simple, it will be O(A(P)I each time.

The O(N*) in the description appears twice (the second in a loop), but it has a special meaning. Because the “cursor” used to count the number of elements greater than the partition will already be indexed into the array, it will have to move less far for each successive choose of partition, as the change gets smaller and smaller. In particular, one can expect the seek distance to half with each successive choice. Alternatively, one could view it that the cursor will not have to travel further than all the way across the array. Under both ways of stating the work involved. It is clear that the sum total of work in this step is O(N). This all works out as 0(A(P)+N+Ln(N)*(1+A(P)))=0(N+Lin(N)*A(P)).

More concretely, the following C/MPI code does the above for arbitrary integer arrays;

```
void biggest_N(int *narray, int *result, int size, MPI_Comm Comm)
{
int imin, imax, sum, numprocs, point;
double min, max, partition;
imin imax sum = numprocs = point = 0;
min = max = partition = 0;
MPI_Allreduce(narray+0,  &imax, 1, MPI_INT, MPI_MAX, Comm}; max = imax;
MPI_Allreduce(narray+size−1, &imin, 1, MPI_INT, MPI_MIN, Comm}; min = imin;
partition = (max + min ) / 2.0;
while ( (point < size−1) && (narray[point] > partition) )
    ++point;
while (sum != size) (
      MPI_AIlreduce(&point, &sum, 1, MPI_INT, MPI_SUM, comm);
        if (sum != size) {
            max = partition
            partition m (max + min ) / 2.0;
            while ( (point < size) && (narray[point] partition) )
                ++point;
        else if (sum > size)
            min = partition;
    partition = (max + min ) / 2.0;
      while ( (point  0) && (narray(point−1) < partition) ) − −point;
}
MPI_Comm_size (comm, &numprocs);
{
      int i ;
      int elements [numprocs] ;
      int displs [numprocs] ;
MPI Allgather(&point, 1, MPI_INT, elements, 1, Comm);
    displs (0) = 0;
    for (i=1; i<numprocs; ++i)
        displs(i) = dipls[i− 1] + elements [i−1] ;
    MPI_Allgatherv(narray, point, MPI_INT, result, elements, displs, MPI_INT,
comm)
}
```

While this second method uses a gather operation, it is gathering only the final result values which are the top N elements. Before the gather operation, each local node knows how many of the global top N elements it has. It can then do a gather operation if desired to consolidate the list of N largest elements to a single node.

Now the code above will be described with regard to the flowchart in FIG. 4. First, the speculative array evaluation process 160 is initialized to step 161. The initialization includes the establishment of data values for particular data structures utilized in the speculative array evaluation process 160. At step 162, a number is received indicating the number of elements 121-129 in the array 120 are to be evaluated.

At step 163, the largest and smallest values of elements 121-129 in all arrays 120 on all CPUs 110 is determined. At step 164, the average or median value between the smallest array element value and the largest array element value is computed. At step 165, the speculative array evaluation process 160 on the local CPU 110 determines the number of elements 121-129 in the local array 120 that are greater than the average value computed at step 164. This number is then submitted to the global combining network 104 in order to enable the next step. At step 165, the global number of elements that are greater than the average is determined. The global sum of all elements greater than the average is determined by receiving from the global combining network 104 the number of elements 121-129 in each of arrays 120 on all CPUs 110 that exceed the average value.

At step 167, it is determined if the global sum of elements greater than average is less than the size or number of array elements to be evaluated. If it is determined at step 167 that the global stun is not less than size or number of elements to be evaluated, then the speculative array evaluation process 160 proceeds to step 173. However, it is determined at step 167 that the sum is less than size. Then the average is recomputed by adding the current average to the smallest array value and dividing by two at step 171. At step 172, the speculative array evaluation process 160 on the local CPU 110 determines the number of elements 121-129 in the local array 120 that are greater than the average value computed at step 171. Speculative array evaluation process 160 then returns to step 166.

At step 173, it is determined if the global sum of elements greater than average is greater than the size or number of array elements to be evaluated. If it is determined at step 173 that the global sum is not greater than size or number of elements to be evaluated, then the speculative array evaluation process 160 proceeds to step 176. However, if it is determined at step 173 that the sum is greater than size, then the average is recomputed by adding the current average to the largest array value and dividing by two at step 174. At step 174, the speculative array evaluation process 160 on the local CPU 110 determines the number of elements 121-129 in the local array 120 that are greater than the average value computed at step 174. Speculative array evaluation process 160 then returns to step 166.

At step 176, it is determined if the global sum of elements greater than the current average is equal to the size or number of array elements to be evaluated as determined at step 162. It is determined at step 176 that the global sum of elements is not equal to the number of array elements to be evaluated, then the speculative array evaluation process 160 returns to step 166. However, if it is determined at step 176 that the global sum of elements is equal to the number of array elements to be evaluated, then the speculative array evaluation process 160 gathers the array of the largest elements at step 177 and exits at step 179.

The present invention can take the form of an entirely hardware embodiment, an entirely software embodiment or an embodiment containing both hardware and software elements. In the exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A distributed array element extraction system for a computer system comprising a plurality of processors, the system comprising:
a module that populates a local array with elements from input;
a module that submits a largest element value in the local array and a processor ID for a local processor;
a module that determines a globally largest element value from the largest element values submitted by each one of the plurality of processors;
a module that broadcasts a winning globally largest element value and winning processor ID to the plurality of processors; and
a module that increments an element pointer to a next value in the local array whenever the winning processor ID equals the processor ID for the local processor.

2. The system of claim 1, further comprising:
a module that inserts a winning global largest element value into a result array.

3. The system of claim 2, further comprising:
a module that decrements a number of array elements to be evaluated.

4. A method for extracting elements from distributed arrays on a parallel processing system, comprising:
populating a local array with elements from input;
submitting a largest element value in the local array and a processor ID for a local processor;
determining a globally largest element value from the largest element values submitted by each one of a plurality of processors;
broadcasting a winning globally largest element value and winning processor ID to the plurality of processors; and
incrementing an element pointer to a next value in the local array if the winning processor ID equals the processor ID for the local processor.

5. The method of claim 4, further comprising;
inserting a winning global largest element value into a result array.

6. The method of claim 5, further comprising;
decrementing a number of array elements to be evaluated.
